(19) United States
(12) Patent Application Publication
(10) Pub. No.: US 2022/0404773 A1
(43) Pub. Date: Dec. 22, 2022

(54) LATERAL LUBRICATION OF COAXIAL TUBES

(71) Applicant: ETA SA Manufacture Horlogere Suisse, Grenchen (CH)

(72) Inventor: Raphael BALMER, Vicques (CH)

(73) Assignee: ETA SA Manufacture Horlogere Suisse, Grenchen (CH)

(21) Appl. No.: 17/779,239

(22) PCT Filed: Nov. 5, 2020
(86) PCT No.: PCT/EP2020/081192

§ 371 Date: May 24, 2022

(30) Foreign Application Priority Data
Nov. 25, 2019 (EP) 19211207.6

(51) Int. Cl. G04B 31/08; G04B 19/04

(52) U.S. Cl. CPC G04B 31/08; G04B 19/044

(57) ABSTRACT

A timepiece mechanism includes at least two coaxial tubes that include a lateral opening so as to be able to be aligned and to receive a lubricant. A lubrication method for coaxial tubes of a timepiece mechanism includes assembling the coaxial tubes, aligning and injecting a lubricant into the opening.

### TECHNICAL FIELD

The field of the present invention relates to that of watches, in particular that of coaxial tubes. More specifically, the field of the present invention relates to that of pipes for indicators.

### TECHNOLOGICAL BACKGROUND

In the field of watchmaking, the coaxial tubes of the indicators, more commonly called pipes, are coaxially assembled tubes. However, the lubrication of these tubes is made difficult and it is not obvious to check whether the lubricating oil is well in the desired location after assembly of the concerned parts.

Indeed, the lubricant is deposited on the coils of the tubes before assembly, then the latter are assembled on top of each other axially. During this assembly, the deposited oil can be pushed with one of the tubes, which displaces the lubricant on one of the faces of the tube, and, in some cases, causes a gluing in the mechanism and often between 2 wheels, or with one of the tubes.

### SUMMARY OF THE INVENTION

The present invention relates to a timepiece mechanism comprising at least two coaxial tubes, preferably at least two pipes; said at least two coaxial tubes, preferably said at least two pipes, both comprising a lateral opening so as to be able to be aligned with each other.

Thanks to this arrangement, it is possible to lubricate said at least two coaxial tubes, preferably said at least two pipes in a single operation and this independently of the number of coaxial tubes. Moreover, the lubrication of said at least two coaxial tubes, preferably said at least two pipes, is guaranteed.

According to one embodiment, the timepiece mechanism comprising an outer tube, preferably outer pipe, configured to receive said at least two coaxial tubes, preferably said at least two pipes.

Thanks to this arrangement, said outer tube, preferably outer pipe, confines the lubricant into the enclosure thereof and avoids any projections of lubricants at high rotational speed since said outer tube, preferably outer pipe, may not comprise side openings.

According to one embodiment, said outer tube, preferably outer pipe, comprises a lateral opening.

Thanks to this arrangement, it is possible to lubricate said at least two coaxial tubes, preferably said at least two pipes and said outer tube, preferably outer pipe.

The present invention also relates to a lubrication method for coaxial tubes of a timepiece mechanism according to the invention, said lubrication method comprising at least one step of:
Assembling said coaxial tubes, preferably said at least two pipes;
Aligning said lateral openings; and
Injecting a lubricant into said side openings.

Thanks to this arrangement, it is possible to lubricate said at least two coaxial tubes, preferably said at least two pipes, in a single operation and this independently of the number of coaxial tubes. Moreover, the lubrication of said at least two coaxial tubes, preferably said at least two pipes, is guaranteed.

According to one embodiment, said lubrication method comprises at least one step of inserting said at least two coaxial tubes, preferably said at least two pipes in said outer tube, preferably outer pipe after said at least one injection.

### BRIEF DESCRIPTION OF FIGURES

The invention will be described below in more detail using the appended drawings, given by way of non-limiting examples, in which:

FIG. 1 represents a sectional view of the timepiece mechanism 100 according to the invention;

FIG. 2 illustrates a top sectional view of the timepiece mechanism 100 according to the invention; and,

FIG. 3 shows a lubrication method 500 for coaxial tubes according to the invention.

### DETAILED DESCRIPTION OF THE INVENTION

Several problems appear during the assembly of the pipes in timepiece mechanisms, and particularly when two tubes are inserted coaxially because the friction induced during the insertion of a tube in the other one, partially or even totally scrapers the pre-injected lubricant.

It is for this reason that the applicant proposes a timepiece mechanism 100 comprising at least two coaxial tubes 110, preferably at least two pipes 110, and according to the embodiments, said timepiece mechanism 100 also comprises an outer tube 120, preferably outer pipe 120, configured to receive said at least two coaxial tubes 110, preferably said at least two pipes 110.

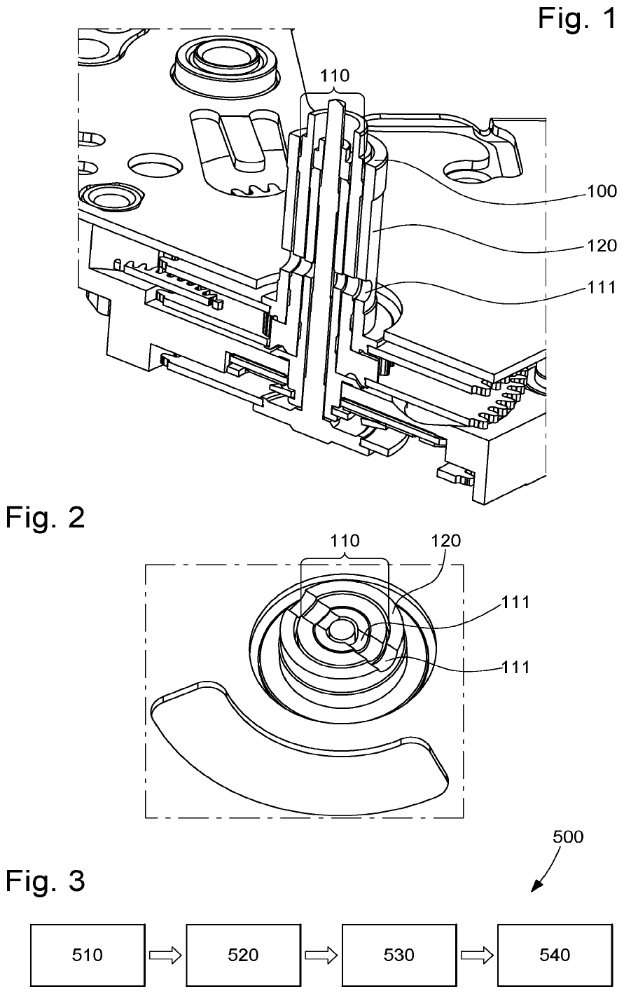

Indeed, as shown in FIG. 1, said at least two coaxial tubes 110, preferably said at least two pipes 110 are, initially, assembled, according to a lubrication method 500 and more particularly during at least one assembly step 510 of said lubrication method 500. Said at least two tubes, preferably said at least two pipes 110, represented in FIG. 1 are tubes mounted on a gear wheel, typically called pipes as defined in the “Illustrated Professional Dictionary of Horology-Berner” such as the seconds wheel, the minute wheel and/or the hour wheel.

Said at least two coaxial tubes 110, preferably said at least two pipes 110 are coaxially assembled and the lateral openings 111 are aligned 520, according to at least one alignment step 520 of said lubrication method 500.

As a result of said at least one alignment step 520, follows at least one step 530 of injecting a lubricant into said side openings 111.

Once said at least one injection step 530 has been performed, said timepiece mechanism 100 is lubricated and said at least two coaxial tubes 110, preferably said at least two pipes 110, are inserted into said outer tube 120, preferably outer pipe 120 during at least one insertion step 540 such that said outer tube 120, preferably outer pipe 120, confines the lubricant into the enclosure thereof and avoids any projections of lubricants at high rotational speed, since in this embodiment, said outer tube 120, preferably outer pipe 120 may not comprise lateral openings 111.

Thus, it is possible to lubricate said at least two coaxial tubes 110, preferably said at least two pipes 110 in a single operation and this independently of the number of coaxial tubes. Moreover, the lubrication of said at least two coaxial tubes 110, preferably said at least two pipes 110 is guaranteed.

According to some embodiments, said outer tube 120, preferably outer pipe 120, may also comprise a lateral opening 111, so as to lubricate the timepiece mechanism 100 even after assembly.

1. A timepiece mechanism comprising:
at least two coaxial tubes,
wherein each of the at least two coaxial tubes includes a lateral opening so as to be able to be aligned with each other.

2. The timepiece mechanism according to claim 1, further comprising:
an outer tube configured to receive said at least two coaxial tubes.

3. The timepiece mechanism according to claim 2, wherein said outer tube comprises a lateral opening.

4. A lubrication method for coaxial tubes of a timepiece mechanism according to claim 1, said lubrication method comprising at least one step of:
assembling said coaxial tubes;
aligning said lateral openings; and
injecting a lubricant into said side openings.

5. The lubrication method according to claim 4, wherein the assembly step includes at least one step of inserting said at least two coaxial tubes in said outer tube.

6. The timepiece mechanism according to claim 1, wherein the at least two coaxial tubes comprise at least two pipes.
